(19) United States
(12) Patent Application Publication
(10) Pub. No.: US 2018/0084932 A1
(43) Pub. Date: Mar. 29, 2018

(54) Knife Rack

(71) Applicant: Nami Khademhosseini, Falls Church, VA (US)

(72) Inventor: Nami Khademhosseini, Falls Church, VA (US)

(21) Appl. No.: 15/829,896

(22) Filed: Dec. 2, 2017

Related U.S. Application Data
(63) Continuation-in-part of application No. 15/462,807, filed on Mar. 18, 2017.
(60) Provisional application No. 62/493,158, filed on Jun. 24, 2016.

(51) Int. Cl. A47G 21/14; A47J 47/00

(52) U.S. Cl. CPC A47G 21/14; A47J 47/005

(57) ABSTRACT

In one example, we describe a device for an efficient and compact rack system for knives and other kitchenware. This stylish design integrates: One or more (e.g., three) grinders, a cutting/chopping board, a tray, and a complete full size knife rack, as an example. All these kitchen tools are specifically designed to fit in the same space that a full-size knife rack normally takes. Many different variations are shown here, as well. For example, we have added a hollow space between the back board and front of the block, for big utensils or objects. We have also an option for a holder for books, pads, tablets, eye glasses, pens, notes, or smart phones. We have also an option for a holder for chopping board or plate or tray, on the back side.

### RELATED APPLICATIONS

This application is CIP of another application Ser. No. 15/462,807, filed on 18 Mar. 2017, with the same inventor, which is based on a provisional application 62/493,158, filed on Jun. 24, 2016, with the same inventor. We claim priority on the above filing dates. We incorporate by reference all the teachings of the above applications in this application.

### BACKGROUND OF THE INVENTION

Usually, in the kitchen and table, there is not enough space for everything needed. So, there is a need for Integrated Knife Rack with Tray and Spice Containers or Grinders, plus Chopping Board. It is a space saver and efficient kitchen countertop rack in which it integrates big pieces of kitchen tools that need to be kept handy, while keeping them organized and saving countertop space at the same time. There is also need for space for tablets, e.g., for reading recipe, or smart phones (I-Pad, tablet, or other electronic devices) or other utensils/tools, e.g., big spoons, pastry blender, potato masher, spatula, serving fork, skimmer, chefs knife, small cleaver, whisk and slotted spoon, spaghetti ladle, sieve, measuring spoon set, bottlebrush, cooking utensil, kitchenware, ovenware, bakeware, kitchen utensils for ovens and baking, cookware, ladle, or others as listed at the website: https://en.wikipedia.org/wiki/Kitchen_utensil.

No other prior art has solved this problem this way and this efficiently.

### SUMMARY OF THE INVENTION

In one embodiment, we describe a method and a device for such a rack system. This stylish design integrates: One or more (e.g., Three) grinders or spice containers, a cutting/chopping board, a tray (e.g., tray and chopping board are either multifunctional pieces or each can be used in the same space separately), and a complete full size knife rack. All these kitchen tools are specifically designed to fit in the same space that a full-size knife rack normally takes. Many different variations are shown here, as well. For example, in one embodiment, we have added a hollow space between the back board and front of the block, for big utensils or objects. We have also an option for a holder for i-Pad or tablet or smart phones or other mobile devices. We have also an option for a holder for chopping board or plate or tray.

### BRIEF DESCRIPTION OF THE DRAWINGS

FIG. 1 is for one embodiment, as an example, for the rack.

FIG. 2 is for one embodiment, as an example, for cylindrical grinders or shakers to keep salt and pepper and other spices. (The grinders may be in cylindrical, rectangular, circular, triangular, or other forms or shapes, in cross section or length.)

FIG. 3 is for one embodiment, as an example, for the rack at side view. Mainly, it shows the cross positioning of the knife blades between the top and lower rows.

FIG. 4 is for one embodiment, as an example, for the cutting board.

FIG. 5 is for one embodiment, as an example, for a tray.

FIG. 6 is for one embodiment, as an example, for side view of the system or assembly.

FIG. 7 is for one embodiment, as an example, for the tray/board that need two small folding legs inside the tray wall. These legs will level the board, when in open position.

FIG. 8 is for one embodiment, as an example, for side view of the system or assembly, with holes on back and bottom, in arrays, as options, with 4 legs underneath, with tray under the legs, with chopping board in the back, held by a support or extension or wall.

FIG. 9 is for one embodiment, as an example, for front view of the system or assembly, with holder or ridge for tablet or phone, e.g., for reading recipe from phone for the cooking in the kitchen.

FIG. 10 is for one embodiment, as an example, for side-front view of the system or assembly, with multiple large openings or slots or slits for large objects for kitchen, e.g., various size knives, including a large box size container at the back side.

FIG. 11 is for one embodiment, as an example, for side-front view of the system or assembly, with multiple large openings or slots or slits for large objects for kitchen, e.g., various size knives/blades.

FIG. 12 is for one embodiment, as an example, for side view of the system or assembly, with chopping board in the back, held by a support or extension or wall, with horizontal section for the salt shakers in front.

FIG. 13 is for one embodiment, as an example, for chopping board, with opening for handle, with extra surface treatment or cover for durability for cutting purposes, e.g., using a polymer or metal or alloy or carbon fiber or the like.

FIG. 14 is for one embodiment, as an example, for side view of the system or assembly, with multiple large openings or slots or slits for large objects for kitchen, e.g., various size knives/blades.

FIG. 15 is for one embodiment, as an example, for side view of the system or assembly, with multiple large openings or slots or slits for large objects for kitchen, e.g., various size knives/blades, including a large box size container at the back side, as option.

FIG. 16 is for one embodiment, as an example, for inside view of the system or assembly, of housing, through the large opening on the top of the housing, to view the ridge on the wall.

FIG. 17 is for one embodiment, as an example, for inside view of the system or assembly, of housing, through the large opening on the top of the housing, viewed from top of the housing.

FIG. 18 is for one embodiment, as an example, for inside view of the system or assembly, of housing, through the large opening on the top of the housing, viewed from top of the housing. It can have the other side/direction covered, as well, or both directions.

### DETAILED DESCRIPTION OF THE PREFERRED EMBODIMENTS

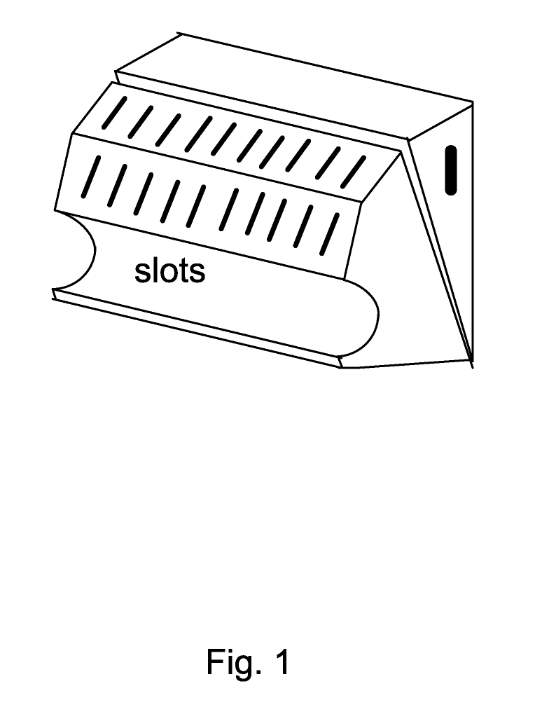

The invention enables efficient usage of the space in the kitchen. These are some variations, embodiments, or examples: The knife rack of FIG. 1 shows the look of the knife rack with the multifunctional board stored in its designated space in the back, between the rack and the wall, in a 90-degree angle to the countertop, which works as a cutting board and tray. The angle can be varied in other embodiments.

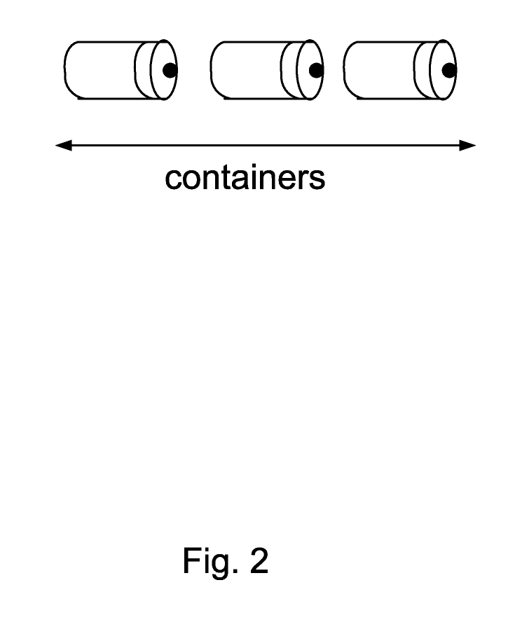

The cylindrical grinder (FIG. 2) is to keep salt and pepper and other spices handy. These grinders are vertically positioned in the concaved groove in front-bottom of the knife rack (FIG. 1). They also use caps to prevent from accidental dispensing. In one embodiment, we have rectangular or oval cross section for the holder/space/groove for grinders and shakers, e.g., for the horizontal space for the salt shaker.

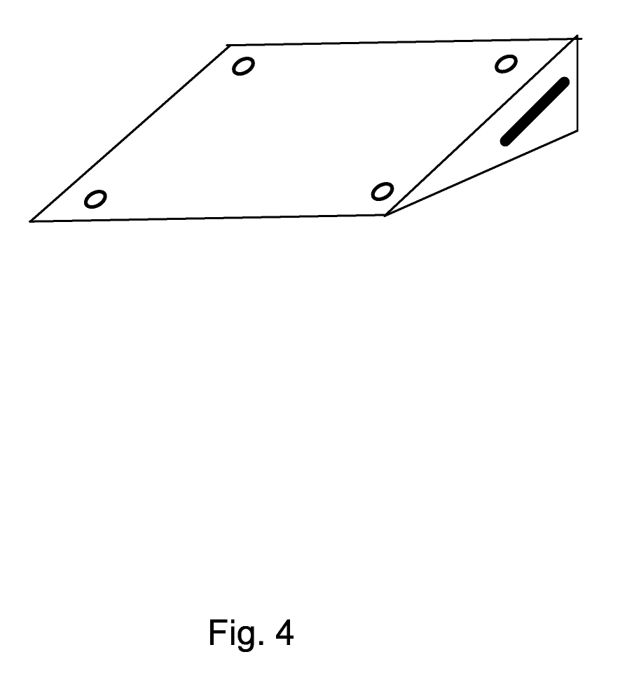

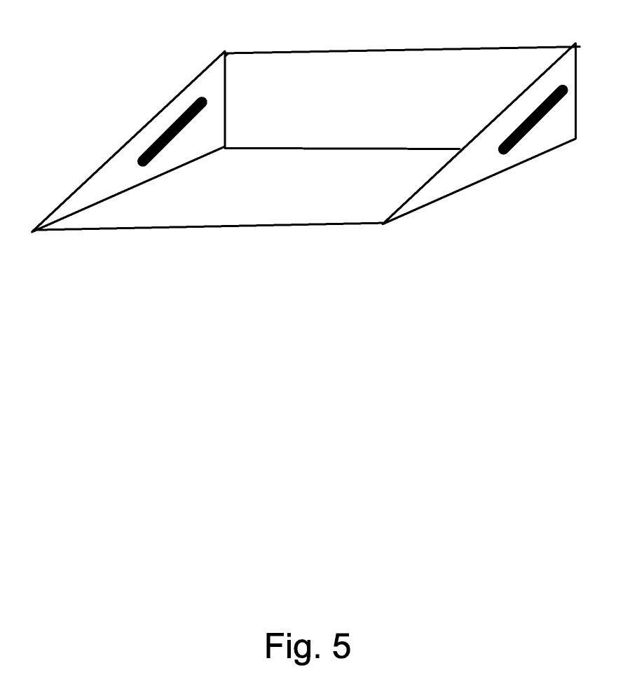

The drawing in FIG. 4 shows the cutting board when is pulled out of the knife rack for use. This piece can easily slide in or out, sideway. FIG. 4 shows the board while is pulled out and placed on a surface to be used as a cutting or chopping board. The same board can be turned over and be used as a tray (FIG. 5). In this position, the four convex buttons on four corners keep the bottom off the table or countertop surface, and in upright position, and when stowed away, it will keep the chopping board surface from touching the wall.

The top knife slots are designed so that they do not cross in 90 degree angle (e.g., less than 90 degrees), to the second row at the bottom, to allow knife blade from top row position in between others at the bottom row. Therefore, the knife handle makes a smaller angle to the horizontal surface of the countertop, and allows the user to put the larger or longer knives out or put back in easily, without bumping her wrist to the top cabinet, which is very inconvenient, especially in the small standard space between the countertops and top cabinets, which is about 18-24 inches, e.g., 20 inches. In one embodiment, we have knife rack section be split in rows in multiple steps of different heights.

This invention also eliminates the storage need for 6 common and frequently used kitchen tools that need to be kept handy on the countertop, and also helps keeping the kitchen organized within one stylish and space-efficient unit, that takes the same space as a full-size conventional knife-rack.

In one embodiment, we have:

1. Each row of knife holder slots on this rack is designed with two different angles for two sets of positioning in the rack, which facilitates placing or removing the knives in and out of the rack, for example, within the small space between the kitchen countertop and the top wall mounted cabinets (about 18-24″), by creating a closer or smaller angle to the horizontal plane/support surface (countertop), where the rack is placed on.

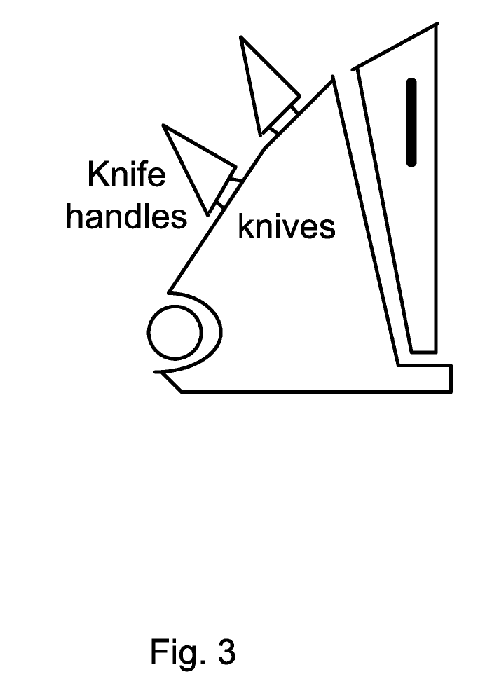

The top row of knife slots can have up to 75 (e.g., about 70) degree angle, as one example, and the lower row can be more than e.g. 30 degree angle, to the countertop surface, which is placed in between the top rows (FIG. 2). In one embodiment, we have the lower row of slots positioned in different vertical zone, comparing to the upper row, and placed in between the upper row of knife slots (FIG. 3).

The said positioning allows the blade of the knives in the lower row of slots to fit in between the knives' blades' tips that are put in the upper row, so that the knives in upper slots and lower slots do not intersect, therefore, all the knives in both rows fit in the rack properly.

2. The tray and chopping board are actually one-piece with different use on each sides, and can be used for either purpose (tray or chopping board), as the user reverses the part or turns it upside down. The said part can slide behind the rack in the space between the rack and the wall behind the rack, over the narrow slot along the width of the rack at the bottom, and behind the rack.

The said slot that holds the narrow side of the tray/chopping board part not only helps with space efficient storing, but also helps with draining the tray and chopping board, while this multipurpose part is in the stored position in the back of the rack (FIG. 1).

3. The rectangular tray and chopping board combination can be used in two different positions: When used with surface up (FIG. 4), it can be used as chopping board with a slight slope towards the user, and higher side away from the user.

When the said part is reversed with the hollow side up, it can be used as a tray (FIG. 5). The said part comprises of four small convex buttons, or like ridge, on each corner, that works as small supports or legs which separate the bottom surface of the part from any surface the tray is put on, in order to keep the bottom chopping board surface touch-free and clean.

The said part is used as a tray when the surface is down. It provides space inside to put anything needed in the tray, and has a hollow space on each of the right and left rectangular sides, which can be used as handles to carry the tray.

4. This design shows a new horizontal positioning of spice cellars or grinders (FIG. 2), in the horizontal space designed in the front of the rack.

The integrated rack (FIG. 1) shows the look of the knife rack with the multifunctional board stored in the back, between the rack and the wall behind it, in 90 degree angle, which works as cutting board on one side and tray on the reverse side.

Cylindrical spice shakers (grinder/shaker) (FIG. 2) is vertically positioned in the groove in front-bottom of the knife rack (FIG. 1). The drawing in FIG. 4 shows the cutting board when is pulled out of the rack for use. It has slope that is placed towards the user, while in use as cutting or chopping board.

The said part can be turned over and be used as a tray (FIG. 5). The said surface has four small convex supports on each corner, which prevent the cutting board surface under the tray from touching other surfaces, such as countertop and tables in order to keep it contact-free and clean.

The slots for holding knife are designed to allow knife blade from top row positioned in between others in bottom row, as perpendicular, therefore, the knife handle making a smaller angle to the horizontal surface of table or countertop, and allowing the user to put the long knives easily in the small space between the countertop and top cabinets, which is about 24 inches, for example.

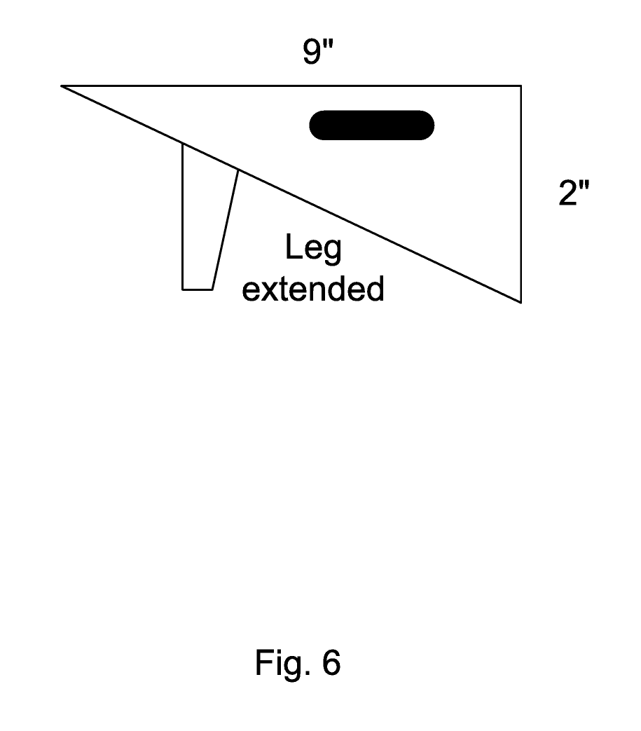

FIGS. 5 and 6 show the tray/board that can incorporate two small folding legs inside the tray wall. These legs will level the board, when in open position. In one example, these small legs are part of the tray wall, when in closed position. This design eliminates the storage need for at least 5 necessary kitchen tools including knife rack, two grinders, tray, and chopping board that need to be kept handy at all times. By doing so, all the space for storing these kitchen tools integrates into a one efficient and space saving rack.

The other embodiments are described below, referring to pages of Figures in Appendix 1, FIGS. 1-18:

1) The first photo shows that the triangular tray wall. Finger tip slot has an angle to the top of the triangular wall, which creates a special ergonomic angle between the palm, wrist, and the arm of the user, creating a comfortable position.

2) It shows that the foldable legs can transfer the tray (in reverse position) to a chopping board that has a clearance space under, to place a container, in which the chopped food is dropped from the chopping board surface.

3) It shows the capacity of the knife rack, and how many pieces of kitchenware it is capable of storing, very efficiently, with least space taken from the kitchen countertop.

4) It shows how the tray part is put or removed from the rack.

5) & 6) It shows the close up of the mechanism of the folding leg inside the tray wall.

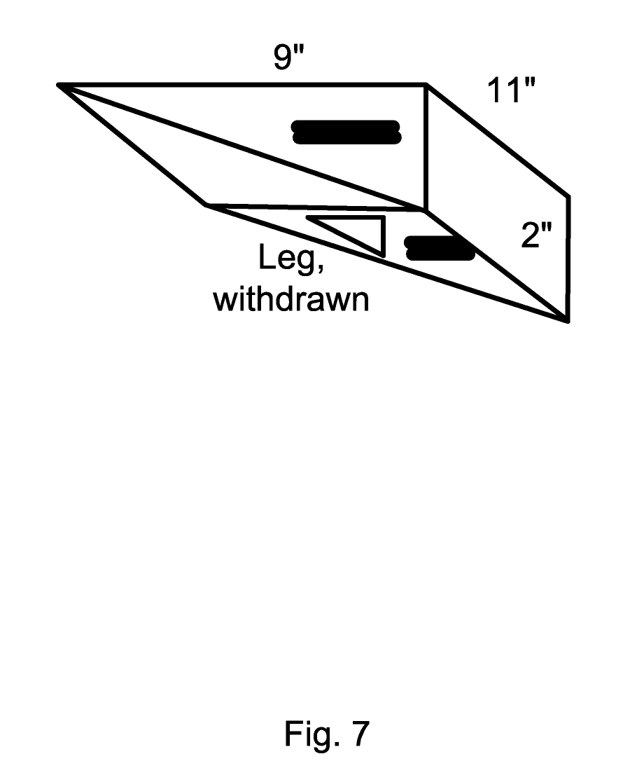

Note that the first 6 photos in Appendix 1, FIGS. 1-6, mentioned above, are examples for the main invention, and the rest, Appendix 1, FIGS. 7-18, are additional photos in different angles, for variations and better descriptions. Appendix 2, FIGS. 1-2, are also additional photos in different angles, for variations and better descriptions.

In one embodiment, we have: A knife rack system, said system comprising: a housing; one or more slots for holding one or more knives within said housing; a board; and a spice container section. Other variations are:

a tray.

chopping board without folding legs.

chopping board with suction units for stability.

wherein said board is converted to a tray.

a knife sharpening tool.

one or more legs or stands or arms.

one or more legs or stands or arms which is foldable.

said one or more slots are at least 2 slots, and said one or more slots have different sizes or dimensions for slots.

said one or more slots are at least 2 slots, and said one or more slots have different angles or directions for slots.

said one or more slots are at least 2 slots, and said one or more slots have same sizes or dimensions for slots.

said one or more slots are at least 2 slots, and said one or more slots have same angles or directions for slots.

an inclined surface.

a handle or grip location.

one or more hinges.

a slide flat tray.

a spice container.

one or more spice containers or grinders.

salt/pepper shakers or containers.

one or more gaps for air circulation.

a bottom tray for water drainage under said housing, with one or more gaps in said housing.

said housing is waterproof or water-resistant.

said housing is made of metal, alloy, wood, or plastic.

one or more elastic suction units under said housing, for stability or grip of said housing on a countertop or table, so that the housing does not move or get toppled down, holding tight to the surface underneath.

For the regular Figs., we have: FIG. 1 is for one embodiment, as an example, for the rack. FIG. 2 is for one embodiment, as an example, for cylindrical grinder to keep salt and pepper and other spices. FIG. 3 is for one embodiment, as an example, for the rack at side view. FIG. 4 is for one embodiment, as an example, for the cutting board.

FIG. 5 is for one embodiment, as an example, for a tray. FIG. 6 is for one embodiment, as an example, for side view of the system or assembly. FIG. 7 is for one embodiment, as an example, for the tray/board that need two small folding legs inside the tray wall. These legs will level the board, when in open position. Please note that the sizes and parameters in Figs. are all examples, and not limiting for the general teaching at all.

Please note that the handle of the tray in figures above can be wide, or narrow, in both directions, and it can be parallel to any of the lines or sides, or not parallel, or in between those lines, e.g., as a bisector line or median line, with respect to each side or face of the object or plane of the object. So, the direction of the handle gap or slit or slot or opening or hole or cross section can go from parallel to perpendicular, and to any angle in between, with respect to each side or face of the object or plane of the object or tray. The shape of the handle gap or slit or slot or opening or hole or cross section can be oval, circle, rectangle, square, triangle, pentagon, polygon, curved-ended, sharp-corners, ellipse, wide line, narrow line or band, or the like.

In one embodiment, we have Integrated Knife Rack with Tray(s), Chopping Board(s), and Spice Containers or Grinders, or other kitchenware or apparatuses or devices or tools, e.g., screw driver or flash light, for other variations.

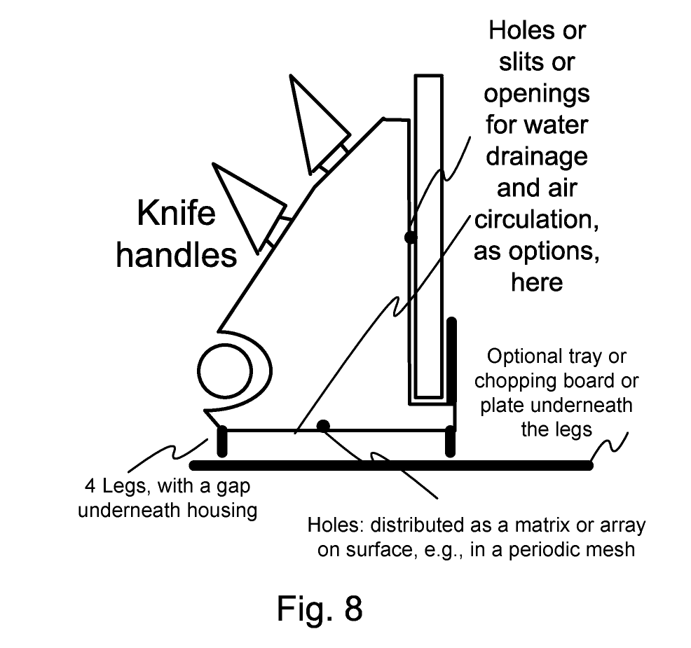

FIG. 8 is for one embodiment, as an example, for side view of the system or assembly, with holes on back and bottom, in arrays, as options, with 4 legs underneath, with tray under the legs, with chopping board in the back, held by a support or extension or wall, with horizontal section for the salt shakers in front, with multiple rows for slits or places or openings or gaps for knives and other utensils for different sizes from front side.

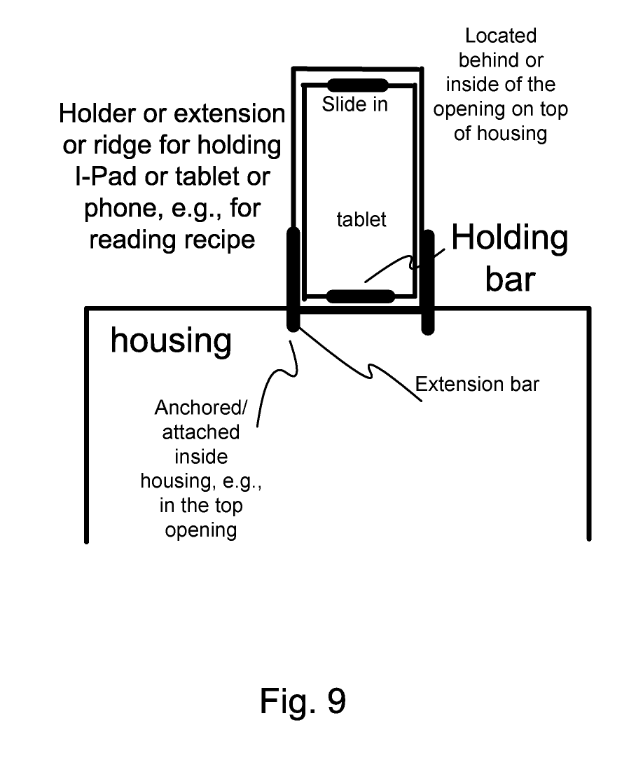

FIG. 9 is for one embodiment, as an example, for front view of the system or assembly, with holder or ridge for tablet or phone, e.g., for reading recipe from phone for the cooking in the kitchen, as a convenient place to hold that, or for other purposes, e.g., talking on the phone or watching a movie, while cooking. The extension bars can be stationary. The extension bars can be on a rail or telescopic structure or pull-out from housing, which can be extended from the original position inside the housing. The holding bars can be a gap or holder or magnetic or spring-loaded, to hold the object from multiple sides.

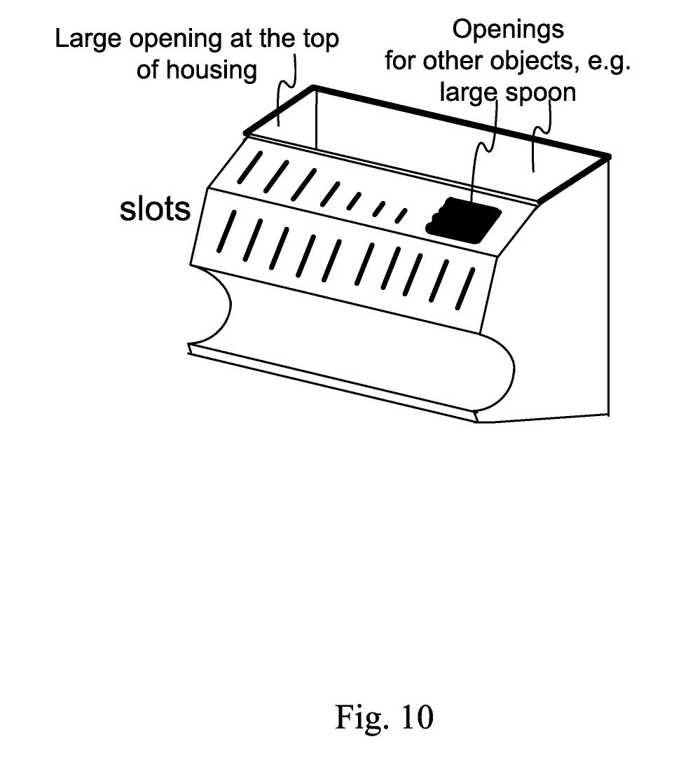

FIG. 10 is for one embodiment, as an example, for side-front view of the system or assembly, with multiple large openings or slots or slits for large objects for kitchen, e.g., various size knives, including a large box size container at the back side, plus a holder section for salt shakers.

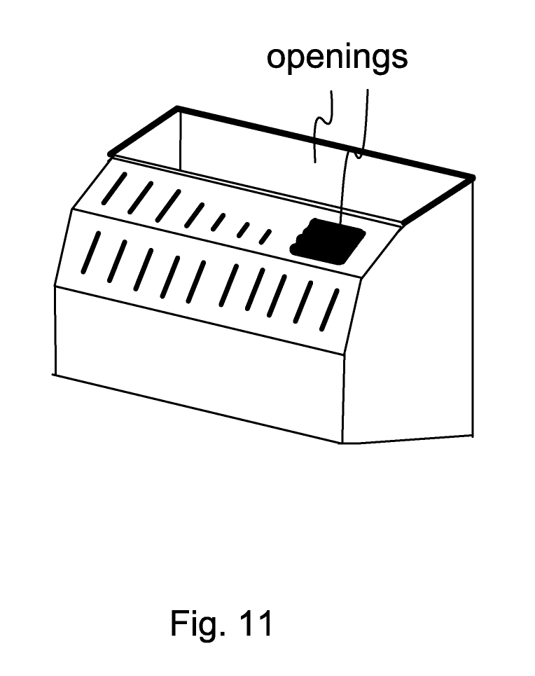

FIG. 11 is for one embodiment, as an example, for side-front view of the system or assembly, with multiple large openings or slots or slits for large objects for kitchen, e.g., various size knives/blades, including a large box size container at the back side. Also, see Appendix 3.

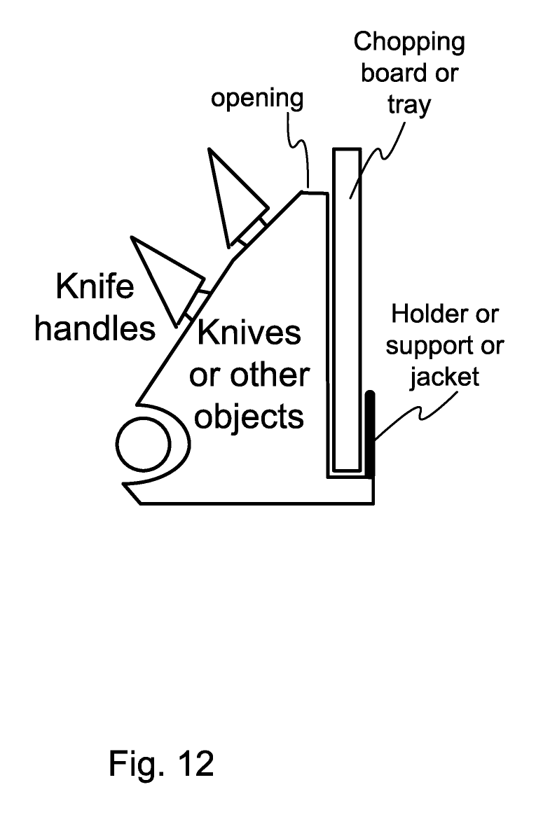

FIG. 12 is for one embodiment, as an example, for side view of the system or assembly, with chopping board in the back, held by a support or extension or wall, with horizontal section for the salt shakers in front, with multiple rows for slits or places or openings or gaps for knives and other utensils for different sizes from front side.

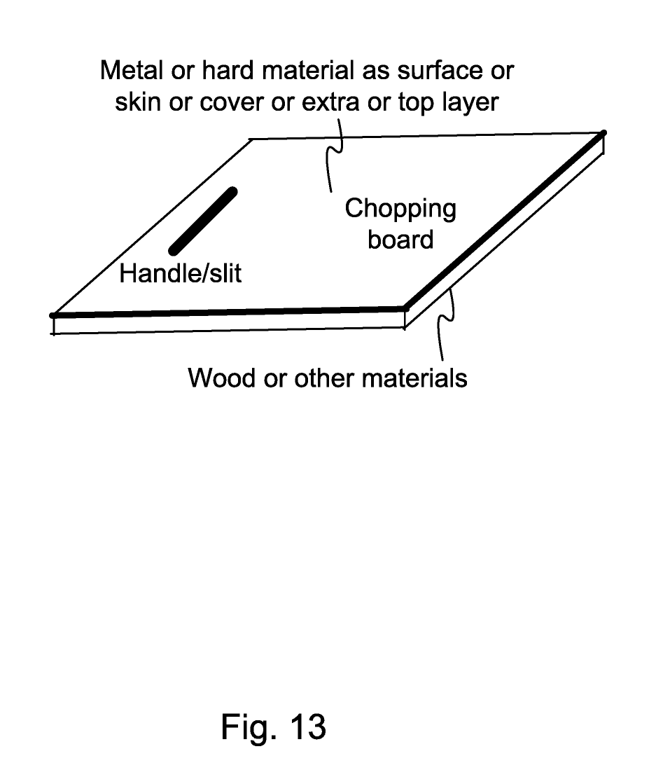

FIG. 13 is for one embodiment, as an example, for chopping board, with opening for handle, with extra surface treatment or cover for durability for cutting purposes, e.g., using a polymer or metal or alloy or carbon fiber or the like.

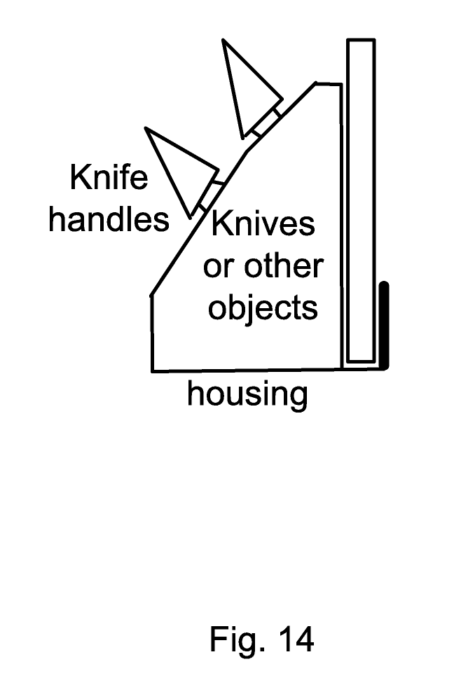

FIG. 14 is for one embodiment, as an example, for side view of the system or assembly, with multiple large openings or slots or slits for large objects for kitchen, e.g., various size knives/blades, including a large box size container at the back side, as option, with chopping block or tray or board standing or held on the back side using a small wall or holder on the back.

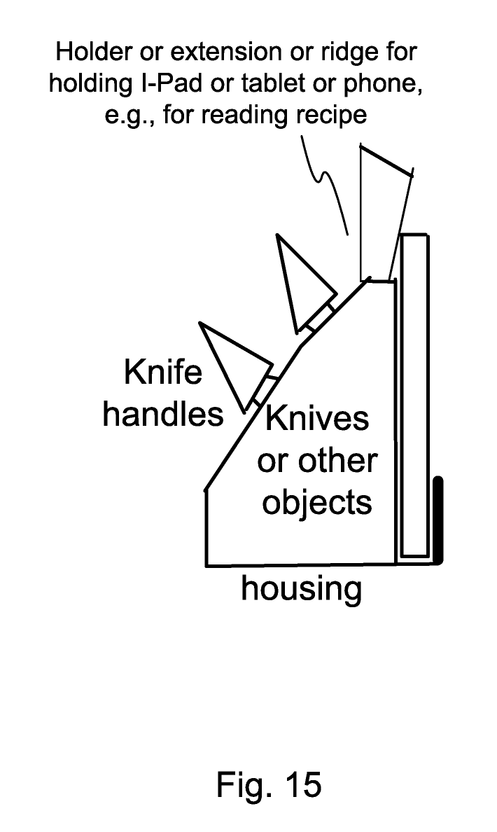

FIG. 15 is for one embodiment, as an example, for side view of the system or assembly, with multiple large openings or slots or slits for large objects for kitchen, e.g., various size knives/blades, including a large box size container at the back side, as option, with chopping block or tray or board standing or held on the back side using a small wall or holder on the back. Also, see Appendix 3. Also, see Appendix 4. It also has an extension or holder for tablet or phone coming out at the top above the housing for easy access to phone or tablet, with an option to fold back or slide down the holder into the housing on a rail or telescopic structure or accordion type folding structure, inside or on the side of the housing or the big opening of the housing for the utensils/tools. Or, it can be a stationary holder/structure, as another option or example/embodiment.

As shown in FIG. 8, the holes in 2D array or matrix or mesh configurations, located on the back or bottom of the housing, provide air circulation or water drainage for the utensils, for dry objects, for better sanitary environments. A tray can be put under the legs of the housing, to collect the drained water underneath the housing, for tossing out later on by a user, or gets dried by itself, in a dry air/atmosphere around the kitchen, for a cleaner environment.

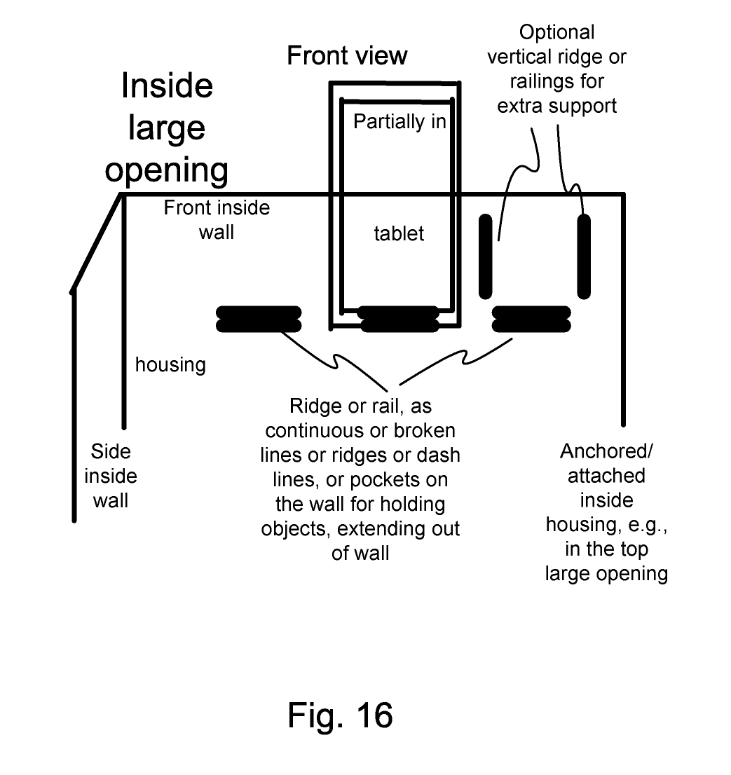

FIG. 16 is for one embodiment, as an example, for inside view of the system or assembly, of housing, through the large opening on the top of the housing, to view the ridge on the wall, to keep the mobile device vertically or almost vertically, hands-free, for user's view in the kitchen/user's convenience. Or, it can be a railing/pocket/short open box, attached to the inside wall, extending out, as continuous or broken lines/patterns. Or, it can have vertical railings, as well, for better support, to hold and keep the device vertically.

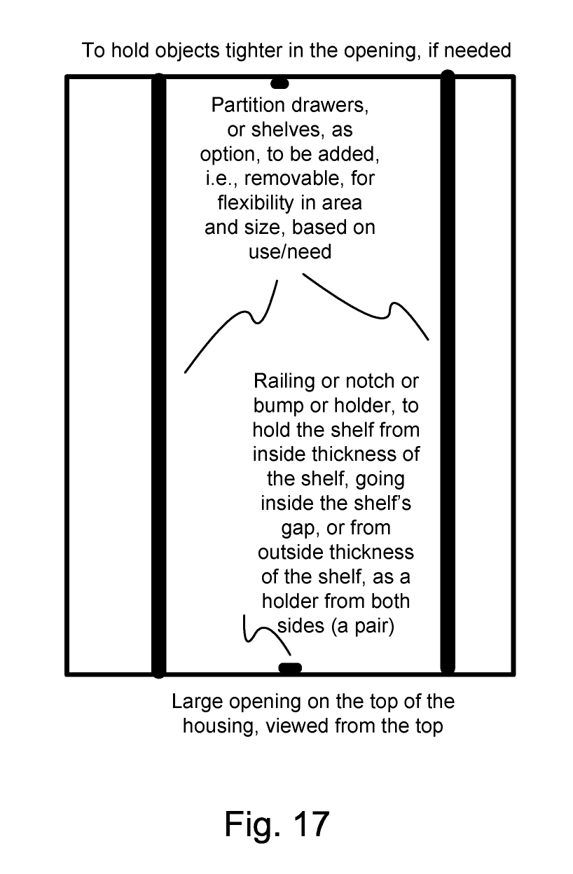

FIG. 17 is for one embodiment, as an example, for inside view of the system or assembly, of housing, through the large opening on the top of the housing, viewed from top of the housing, for side railings or notches, to hold or keep the vertical shelves, as removable partitions for various usages, for extra flexibility for space and objects/sizes, for the best fit and storage of kitchenware.

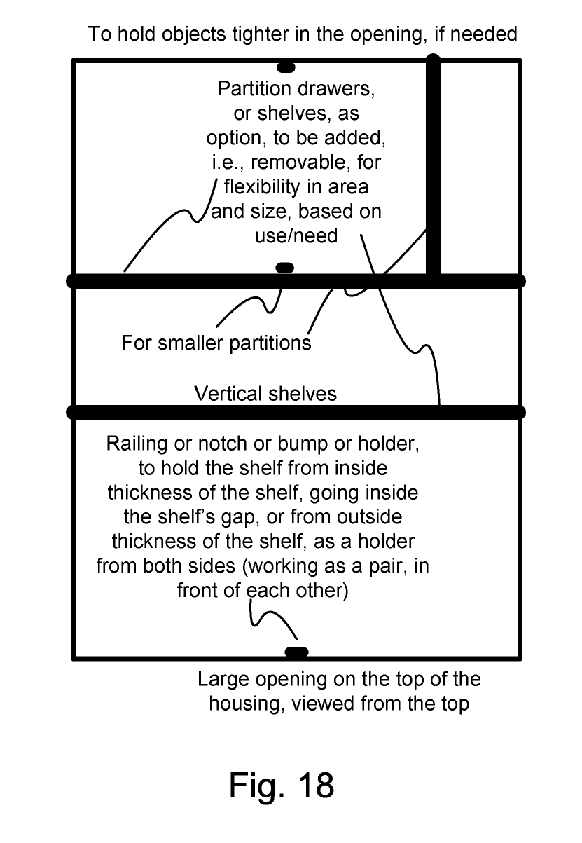

FIG. 18 is for one embodiment, as an example, for inside view of the system or assembly, of housing, through the large opening on the top of the housing, viewed from top of the housing, for side railings or notches, to hold or keep the vertical shelves, as removable partitions for various usages, for extra flexibility for space and objects/sizes, for the best fit and storage of kitchenware. It can have the other side/direction covered, as well, or both directions. It can also have the option for sub-partitioning, for smaller partitions, as needed, for more sections, and smaller sections, as removable shelves, just slide in and out, through/on the wall rails, working as a pair of rails. So, a partition may have a notch/railing itself, on its surface, extending out, for further partitioning inside itself, in a nested structure or configuration.

Note that in one embodiment, there are 2 ways to do the connection above: One way is to have a bump on the wall which goes into the hollow section of the shelf, on the opposing 2 edges of the shelf, fitted in, to slide in, and keep all intact, and to hold the shelf vertical, in this case. The second way is to do the opposite: The wall has a dent or indentation or curve-in or slit or narrow opening or rail inside the wall or going-in surface or carved-out section of the wall, where the extended section of the shelf can go into, around the edges, and get fitted in, to slide in, and keep the shelf in place. These mechanisms can also be used for other parts of this invention to hold things together, as another alternative.

The knife rows could be in multiple step/height configuration or in inclined surface or flat surface, or in combination. All the sizes are just examples, and not limiting at all. All figures in Appendix 5 (FIGS. 1-12) show variations and details/views, or further embodiments of the teachings.

The material and size of the system or apparatus described here can be widely diverse and different, e.g., made of wood, plastic, elastic, rubber, artificial materials, wool, fabric, glass, crystal, metal, alloy, carbon, mortar, concrete, brick, clay, transparent materials, translucent materials, acrylic, stone, artificial stone, compacted stone or powder, glued materials, layered or stacked materials, or the like, and e.g., for sizes around from 0.5″ or 0.5 ft as lower end of the range, to 3-6 ft, as upper range or values, in length and width and height, or other dimensions, in the images shown. However, these numbers and materials are just examples, and not limiting the invention by any means, in spec or figures or for any purpose.

Any variations and combinations of the above teachings are also intended to be covered by this patent application.

1. A knife rack system, said system comprising:
a housing;
one or more slots for holding one or more knives within said housing;
a chopping board; and
a rectangular opening for large kitchen utensils or tools located at back side of said housing.

2. The knife rack system as recited in claim 1, said system comprising:
a pair of scissors.

3. The knife rack system as recited in claim 1, wherein said chopping board has a handle.

4. The knife rack system as recited in claim 1, said system comprising:
a knife sharpening tool.

5. The knife rack system as recited in claim 1, said system comprising:
one or more legs or stands.

6. The knife rack system as recited in claim 1, said system comprising:
one or more legs or stands which are foldable.

7. The knife rack system as recited in claim 1, wherein said one or more slots are at least 2 slots, and said one or more slots have different sizes or dimensions for slots.

8. The knife rack system as recited in claim 1, wherein said one or more slots are at least 2 slots, and said one or more slots have different angles or directions for slots.

9. The knife rack system as recited in claim 1, wherein said one or more slots are at least 2 slots, and said one or more slots have same sizes or dimensions for slots.

10. The knife rack system as recited in claim 1, wherein said one or more slots are at least 2 slots, and said one or more slots have same angles or directions for slots.

11. The knife rack system as recited in claim 1, wherein length of said chopping board is larger than height of said housing.

12. The knife rack system as recited in claim 1, said system comprising:
a handle or grip location or section.

13. The knife rack system as recited in claim 1, said system comprising:
one or more hinges.

14. The knife rack system as recited in claim 1, wherein said one or more slots are at least 3 slots and are located in one or more rows.

15. The knife rack system as recited in claim 1, wherein said system is mounted against a wall or on a bracket attached to a structure or a wall.

16. The knife rack system as recited in claim 1, said system comprising:
one or more gaps for air circulation.

17. The knife rack system as recited in claim 1, said system comprising:
a metal sheet cover.

18. The knife rack system as recited in claim 1, wherein a bottom tray sits under said housing.

19. The knife rack system as recited in claim 1, wherein said housing is made of metal, alloy, wood, or plastic.

20. The knife rack system as recited in claim 1, said system comprising:
one or more elastic suction units under said housing, for stability or grip of said housing on a countertop or table.
